(19) United States
(12) Patent Application Publication
(10) Pub. No.: US 2006/0106664 A1
(43) Pub. Date: May 18, 2006

(54) METHOD, SYSTEM, AND STORAGE MEDIUM FOR DEVELOPING A FORECAST OF GOODS AND SERVICES

(75) Inventors: Daniel J. Peters, Poughquag, NY (US); Mamnoon Jamil, Voorhees, NJ (US)

Correspondence Address: CANTOR COLBURN LLP - IBM FISHKILL, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 10/904,579

(22) Filed: Nov. 17, 2004

(51) Int. Cl. G07G 1/00

(52) U.S. Cl. 705/10; 705/26

(57) ABSTRACT

A method, system, and storage medium for developing a forecast of goods or services. The method includes identifying current or previous goods or services that have characteristics similar to those of a new or replacement good or service to be forecasted. The method further includes obtaining delivery data associated with the current or previous goods or services, and adjusting delivery volume data of the current or previous goods or services for corresponding announce and withdrawn time periods, resulting in a modified delivery data. Using the modified delivery data in conjunction with planned release and withdrawal dates and forecasted time periods and total quantities associated with the new or replacement good or service for the life span, the method includes translating lifecycle patterns for the current or previous goods or services into a lifecycle forecast for the new or replacement good or service.

### BACKGROUND

The invention relates generally to forecasting tools, and more particularly, to a method, system, and storage medium for developing a forecast of goods and/or services based, in part, upon life cycle analysis.

Reliable forecasting of a new or replacement good or service requires a thorough and detailed understanding of life cycle patterns relating to the delivery of the good or service based on demand factors. Typically, a life cycle follows three primary phases: growth, maturity, and decline. It is very common for goods and services to experience variations in its respective life cycles throughout the course of these phases. Further, the actual duration of each phase and the peak of the life cycle curve depend on various factors.

Conventional methods of addressing forecasting of a new or replacement good or service are qualitative and quantitative in nature. Qualitative techniques include opinion driven estimates (i.e., bottoms up, tops down, or Delphi), market research (i.e., primary and secondary), scenarios, historical analogy, and expert judgment, to name a few. Qualitative methods require judgment, can be subjective, and are sometimes biased by human emotions or beliefs. Quantitative techniques are generally comprised of models using averages (i.e., simple or weighted), exponential smoothing, trend extrapolation, statistical or casual models, and time series. Quantitative methods are subject to regression analysis or other mathematical operations.

The standard historical analogy technique involves identification of one or more historical goods or services that demonstrate the same time frame or the length of the life spans that have similar life cycles to the new or replacement good or service. The new or next generation products or services have a shorter life span than the previous products or services. In the traditional quantitative methods, as life cycles are reduced in duration, the precision of the statistical forecast diminishes. Standard historical analogy techniques fail to account for these variations in creating forecasts. What is needed, therefore, is a way to reconcile disparate time frames, including bridging different life spans for products and services in order to generate a single coherent forecast.

### SUMMARY

Exemplary embodiments relate to a method, system, and storage medium for developing a forecast of goods and services. The method includes identifying current or previous goods or services that have characteristics similar to those of a new or replacement good or service to be forecasted. The method further includes obtaining delivery data associated with the current or previous goods or services, and adjusting delivery volume data of the current or previous goods or services for corresponding announce and withdrawn time periods, resulting in a modified delivery data. Using the modified delivery data in conjunction with planned release and withdrawal dates and forecasted time periods and total quantities associated with the new or replacement good or service for the life span, the method includes translating lifecycle patterns for the current or previous goods or services into a lifecycle forecast for the new or replacement good or service.

### BRIEF DESCRIPTION OF THE DRAWINGS

The foregoing and other objects, aspects, and advantages will be better understood from the following detailed description of preferred embodiments of the invention with reference to the FIGURES, in which:

FIG. 1 is a diagram illustrating the system architecture upon which a life cycle analysis forecast for a new or replacement good or service is implemented in an exemplary embodiment;

FIG. 2 is a flow diagram describing the forecasting process for a new or replacement good or service based on life cycle analysis in an exemplary embodiment;

FIG. 3 is a template illustrating the cumulative delivery percentage calculations for current or previous goods or services in an exemplary embodiment;

FIG. 4 is a template illustrating the linear adjustment calculations for current or previous goods or services calculations in an exemplary embodiment;

FIG. 5 is a template illustrating the weekly demand skew adjustment calculations (in monthly time periods) for current or previous goods or services in an exemplary embodiment;

FIG. 6 is a template illustrating the weekly demand skew adjustment calculations (in quarterly time periods) for current or previous goods or services in an exemplary embodiment;

FIG. 7 is a template illustrating the monthly demand skew adjustment calculations (in quarterly time periods) for current or previous goods or services in an exemplary embodiment;

FIG. 8 is a template illustrating the life cycle percentage calculations for current or previous goods or services based on forecasted life span of new or replacement good or service in an exemplary embodiment;

FIG. 9 is a template illustrating the forecasted volume calculations for new or replacement good or service in an exemplary embodiment;

FIG. 10 is a template illustrating the linear adjustment calculations for new or replacement good or service in an exemplary embodiment;

FIG. 11 is a template illustrating the weekly demand skew adjustment calculations (in monthly time periods) for new or replacement good or service in an exemplary embodiment;

FIG. 12 is a template illustrating the weekly demand skew adjustment calculations (in quarterly time periods) for new or replacement good or service in an exemplary embodiment;

FIG. 13 is a template illustrating the monthly demand skew adjustment calculations (in quarterly time periods) for new or replacement goods or service in an exemplary embodiment; and

FIG. 14 is a graphical representation of life cycle demand patterns and forecasted volumes in an exemplary embodiment.

### DETAILED DESCRIPTION

A forecast of a good or service is developed using a forecast decision support system. The forecast decision support system utilizes a process that is based, in part, on life cycle analysis (using delivery volume information) of similar goods or services. The forecast decision support system methods develop intermediate and long term forecasts for a new or replacement good or service using weekly and monthly data, and accounts for any demand skew within the data. Before the good or service is announced to the market, the methodology of the forecast decision support system credibly predicts the demand pattern of the new or replacement good or service.

The forecast decision support system process is sufficiently robust to handle dynamic business environments and is portable across business models, business units, goods, or services. One impact of this process is that goods and services will be available to customers when they want them. A credible and actionable forecast is generated via the method and is designed to drive overall business execution, which includes providing a rational determination of the investments required during the life span of the good or service, and a determination of when that cash flow is required to sustain the sales effort. It will be appreciated that the forecast decision support system may be utilized for a variety of applications including demand management, sales, marketing, forecasting, order management, manufacturing, service industries, utility providers, and consultancy fields.

Various terminology, as provided herein, is defined below for clarification.

Good. A good refers to a manufactured, tangible entity that has economic utility, satisfies an economic want, or possesses intrinsic value (excluding financial instruments) and may be provided in exchange for monetary or other compensation.

Service. A service refers to a useful labor, activity, or utility (e.g., legal, consulting, communications, transportation, natural gas, electricity, fuel oil, water, etc.). A service may be provided in exchange for monetary or other compensation.

Delivery. A delivery refers to a legal transfer, or installation, of a good or service from a seller to a buyer for monetary or other compensation.

Previous Good or Service. A previous good or service refers to one that has reached the end of its economic life, or has been withdrawn from the market place, and has been superseded by a new or replacement good or service. The delivery data for a previous good or service is based on historical records.

Current Good or Service. A current good or service refers to a currently existing good or service that has exceeded its peak demand but has not reached the end of its economic life. The delivery data for a current good or service is segmented into two elements, namely, historical records of deliveries to date, and estimated delivery projections based on the remaining life cycle.

Life Span. Life span is the time duration between announce and withdrawn dates. The life span is segmented into time periods (i.e., weeks, months, quarters, etc.) which relate to the method of collecting and aggregating delivery data.

Estimated Delivery Projections. Estimated delivery projections of current goods or services are based on the following criteria: percentage of life span completed, volume of remaining deliveries, distribution of the remaining deliveries, and number of remaining time periods. An estimation of the delivery data of the remaining life cycle is required for the calculation of the Delivery Percentages for current goods or services.

New Good or Service. A new good or service is one that has been recently announced and appears for the first time. A “new” good or service is not a “replacement”.

Replacement Good or Service. A replacement good or service refers to one that partially or wholly, or sequentially or overlapping (e.g., is somewhat concurrent), either supplants a current good or service or supersedes a previous good or service. A replacement good or service is not “new”, but is either a substitute (i.e., equivalent alternative) or an improved version.

Life Cycle. A life cycle refers to a good or service's distinguishing phenomena of development, growth, and adaptation to marketplace conditions, or the continuous sequence of changes from one primary form to the development of a similar replacement form.

Life Cycle Percentage. A life cycle percentage refers to a good or service's delivery data for a specific time period divided by the total delivery volume over its entire life cycle.

Demand Skew. The asymmetrical desire from one time period to the next to purchase goods or services based upon price, marketing communications, promotional activities, and other incentives and is combined with a power to buy.

Forecasting new goods or services, and to a lesser extent, replacement goods or services can be a difficult process. Even though future demand assumes some degree of uncertainty, predictive models can provide business insight into future demand patterns. The forecast decision support system's systematic use of delivery data provides an advantage over other forecasting techniques. Additionally, the method enabled by the forecast decision support system may be adapted to update the forecast by adjusting the forecasted volumes and/or weights based on the early delivery data, usually within the first several time periods associated with the new or replacement good or service.

If used with an exploded bill of material (BOM) structure, the method can be informative as to volume of good or service components required over the life span, continuity of service, and resource planning with appropriate lead times. The method assists decision makers and planners to develop schedules, negotiate contracts, conduct marketing campaigns, make infrastructure investments, and plan hiring activities. The method is also applicable to manufactured goods whose manufacturing methodologies are build-to-order, make-to-stock, or configure-to-order. The method, with associated tools, system architecture, and storage medium lends itself to automation of the results and display in a graphical form.

This method combines the strengths of qualitative and quantitative methods by using historical analogies, time series data, and demand skew information with a normalization technique and mathematical rigor. The inherent assumptions of the method include: delivery data is reliable; unforeseen or unique circumstances can be influenced with decisive action; and a derived forecast has a reasonable fit to future life cycles of a good or service.

The method permits the forecasting of complementary goods and services that may be delivered simultaneously or sequentially. This can be expressed as a “parent-child” pair. The “parent” forecast will have similar curve to the “child” forecast. For example, the delivery volumes for a hardware product (good parent) may stimulate similar demand patterns for software (good child) and learning engagement (service child). The “child” forecast volumes may be different than the “parent” forecast volumes due to conversion rates between the “parent” deliveries and “child” demands.

The method is adaptable to seasonal goods and services. The weighting schema permits assigning more value to one or more patterns over others based on the validity of each historical demand patterns. For example, a pattern may have a lower weight relative to the others due to unusual circumstances surrounding the delivery of that good or service (i.e., during the past five years of delivery data, the fourth year has unseasonably cool weather, hence the fourth year's delivery data would have a lower weight than the other 4 years).

One of the initial problems in the quantitative technique area is how to adjust delivery information of current and previous goods and services for announce (first) and withdrawn (last) time periods by incorporating demand skew within these time periods. The method addresses this problem and transforms delivery information irrespective of its time frame or the length of the life span to life cycle percentages of the new or replacement good or service. The method further compensates for varying demand skew percentages for each current or previous good or service and enables the user to predict a better forecasted volume of a new or replacement good or service for each time period of its life cycle including the announce period and withdrawn period.

Demand patterns may be uniform, skewed to the right or left, or possess a bi-modal or multi-modal distribution. The traditional methods seek statistical rigor, which may not factor in unique demand patterns. This method provides a simpler, non-statistical predictive model that does not resort to least squares or regression analysis. This simplicity, along with the graphical representation capabilities, provides demand forecasters with a more intuitive model without technical jargon. Optimization of inventory and other resources are conducted in the actual execution or rollout of the good or service, since in many cases with slight demand changes, those situations must be dealt with at those specific times. When those out of bound conditions from the forecast are identified, actions can be initiated to correct that imbalance.

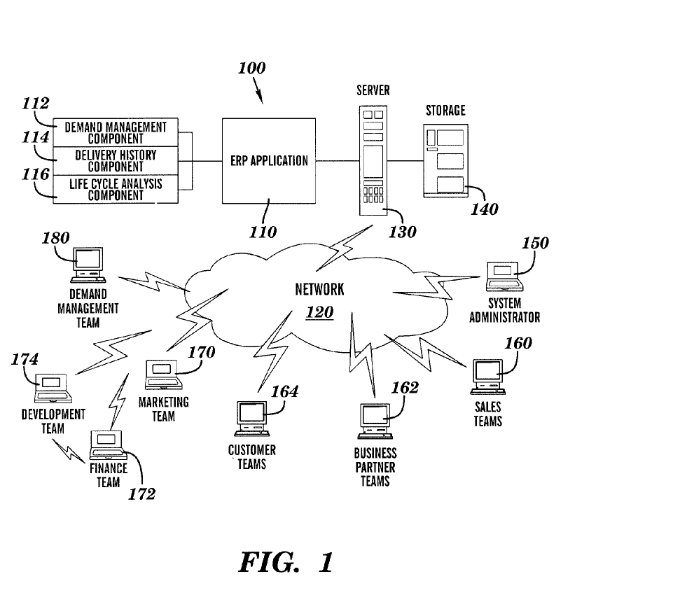

Turning now to FIG. 1, a network system 100 for implementing the life cycle analysis forecast for a new or replacement good or service system will now be described. System 100 includes a host system or server 130 executing an Enterprise Resource Planning (ERP) application 110 with three components: (1) a demand management component 112, (2) a delivery history component 114, and (3) a life cycle analysis component 116. The ERP application 110 and components 112-116 are collectively referred to herein as the forecast decision support system. For purposes of illustration, the non-web components (i.e., 112-116) may utilize IBM's Lotus 1-2-3™ spreadsheets, DB2® databases, or other suitable data intense manipulation programs. ERP application 110 integrates the functionality of components 112-116 as described herein.

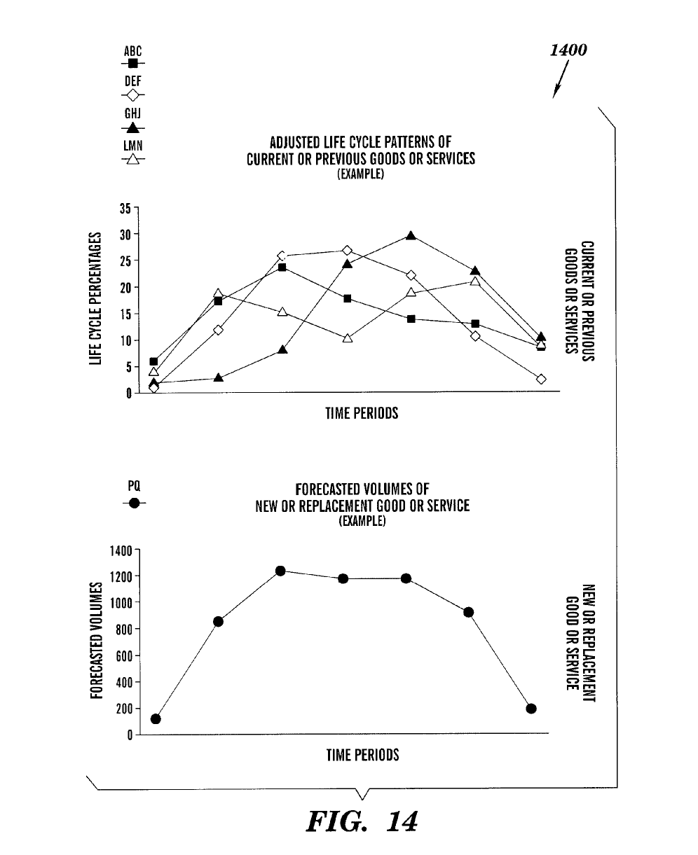

Demand management component 112 contains approved forecast models and parameters for the enterprise of system 100. This component 112 also provides graphical representation capabilities as embodied in FIG. 14. In accordance with exemplary embodiments, demand management component 112 is managed by demand management and marketing teams.

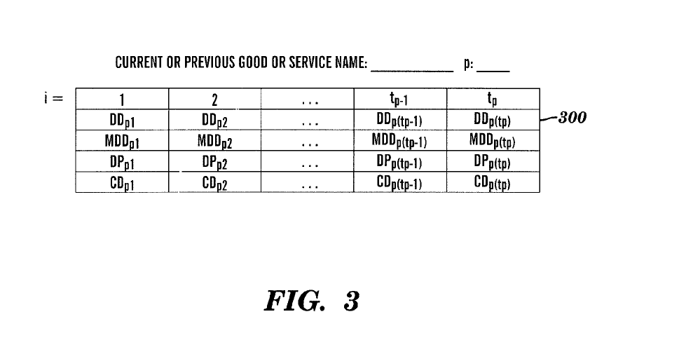

Delivery history component 114 contains delivery data for current and/or previous goods or services. This component 114 includes an input database for receiving cumulative delivery percentages calculations (see FIG. 3). In accordance with exemplary embodiments, demand history component 114 is updated by sales teams, business partners, and customer teams.

Life cycle analysis component 116 provides life cycle analysis templates, parameters, and calculations (see FIGS. 3 through 13). Calculations may be rounded up to the integer level (i.e., no decimals) throughout all of the templates. In the case where current goods or services are used within the model, demand planner(s) estimate the delivery volumes of the remaining time periods (see FIG. 3). In exemplary embodiments, life cycle analysis component 116 is managed by a demand management team.

Host system 130 may be connected through a network 120 to client systems 150-180 or other networks. The host system 130 depicted in FIG. 1 may be implemented using one or more servers operating in response to a computer program stored in a storage medium accessible by the server. The host system 130 may operate as a network server (e.g., a web server) to communicate with the client systems 150-180. Host system 130 handles sending and receiving information to and from client systems 130-180 and can perform associated tasks. Host system 130 executes various applications typically found in a business enterprise.

Host system 130 may also include a firewall to prevent unauthorized access to the host system 130 and enforce any limitations on authorized access. For instance, an administrator may have access to the entire system and have authority to modify portions of the system. A firewall may be implemented using conventional hardware and/or software, as is known in the art.

Host system 130 may also operate as an application server. Host system 130 executes one or more computer programs to implement the forecast decision support system processes and related functions. As previously described, it is understood that separate servers may be utilized to implement the network server functions and the application server functions. Alternatively, the network server, the firewall, and the application server may be implemented by a single server executing computer programs to perform the requisite functions.

Network 120 may be any type of known network including, but not limited to, a wide area network (WAN), a local area network (LAN), a global network (e.g., Internet), a virtual private network (VPN), and an intranet. Network 120 may be implemented using a wireless network or any kind of physical network implementation known in the art. One or more of client systems 150-180 may be coupled to host system 130 through multiple networks (e.g., intranet and Internet) so that not all client systems 150-180 are coupled to host system 130 through the same network. One or more of the client systems 150-180 and the host system 130 may be connected to the network 120 in a wireless fashion. In one embodiment, the network is an intranet and one or more client systems 150-180 execute a user interface application (e.g., a web browser) to contact the host system 130 through the network 120, while another client system is directly connected to the host system 130. In another exemplary embodiment, a client system is connected directly (i.e., not through the network 120) to the host system 130 and the host system 130 is connected directly to or contains a storage device 140.

Storage device 140 may be implemented using a variety of devices for storing electronic information. It is understood that the storage device 140 may be implemented using memory contained in the host system 130 or it may be a separate physical device. The storage device 140 is logically addressable as a consolidated data source across a distributed environment that includes a network 120. Information stored in the storage device 140 may be retrieved and manipulated via the host system 130. The storage device 140 includes a data repository containing documents, data, web pages, images, multi-media, etc. In an exemplary embodiment, the host system 130 operates as a database server and coordinates access to application data including data stored on storage device 140.

Client systems 150-180 may comprise general-purpose computer devices that allow systems to connect to the network 120 and host system 130. Client systems 150-180 may access the host system 130 via internal web browsers located therein. Individual client systems are described below.

Individuals and teams involved in the forecasting of new or replacement goods or services perform specific roles throughout the forecasting processes based on life cycle analysis. They may also be in communication with each other via client systems 150-180.

System administrator client system 150 refers to a computer or workstation operated by individuals or teams that manage the performance, operation, and maintenance of the host system 130, data repository 140, and networks (e.g., 120) identified in the foregoing discussion.

Sales team members enter orders for goods or services into ERP application 110 based upon specific contracts between a buyer and the enterprise via sales team client system 160. Once an order has been shipped and installed at a customer site, delivery history component 114 is updated to reflect this transaction.

Business partner team members enter orders for goods or services into ERP application 110 based on specific contracts between the enterprise and business partner via business partner team client system 162. The business partner may be an intermediary between a customer and the enterprise of system 100. Once an order has been shipped and installed at the customer site, delivery history component 114 is updated to reflect this transaction.

Customer team members, via customer team client system 164, directly enter orders for goods or services into ERP application 110 in accordance with agreed upon network communications between a customer and the enterprise of system 100. Once an order has been shipped and installed at a customer site, delivery history component 114 is updated to reflect this transaction.

Marketing team members identify solution concepts in concert with finance team members and development team members via marketing team client system 170, finance team client system 172, and development team client system 174, respectively. The result of the collaboration includes the identification of new or replacement goods or services for which a forecast is needed based on planned release and withdrawal dates, expected volumes to be sold, etc. The marketing team updates the demand management component 112 and life cycle analysis component 116 with this information.

Demand management team members manage and update new and replacement forecasts for the enterprise of system 100 via demand management team client system 180. The demand management team updates the demand management component 112 and life cycle analysis component 116 as described herein, and analyzes the output of this process.

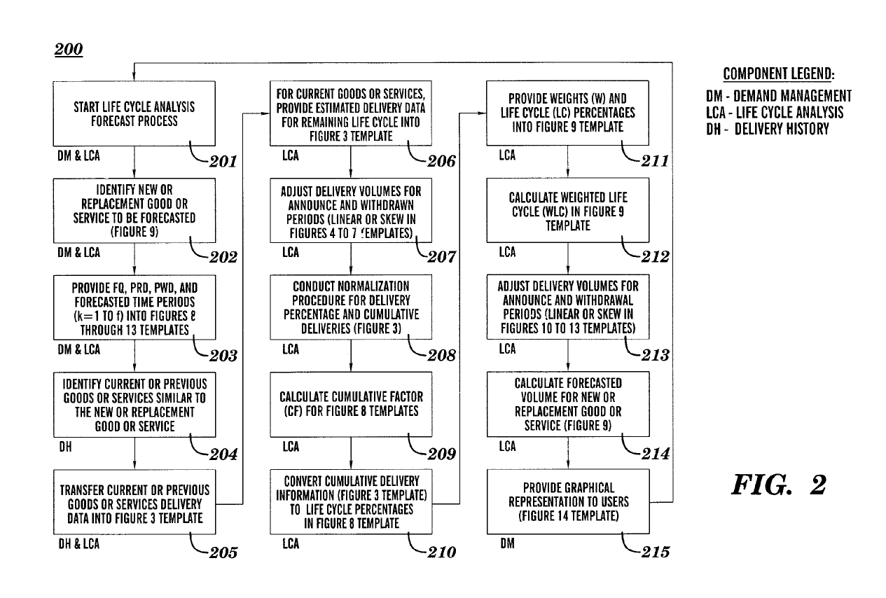

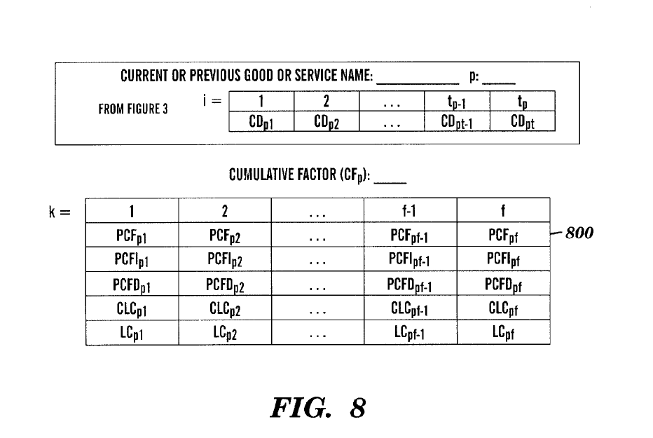

The process flow depicted in the flow diagram 200 of FIG. 2 refers to a life cycle analysis of a new or replacement good or service forecast as will now be described. The demand management team initiates the forecast decision support system process at step 201 and identifies a new or replacement good or service to be forecasted at step 202. To use this method, the marketing and demand management teams coordinate various information concerning the Planned Release Date (PRD), Planned Withdrawal Date (PWD), forecasted time periods (f), and Forecasted Quantity (FQ) of the new or replacement good or service at step 203. This information is appropriately applied in templates 800-1300 of FIGS. 8-13.

Possible choices for estimating a Forecasted Quantity (FQ) of the new or replacement good or service include: identifying which current or previous good or service is close (or similar) to the new or replacement good or service based on total actual deliveries with a growth percentage; using the expert judgment of the marketing, finance, and development teams; using financial plan projections based on revenue and profit targets; or using the product of the total market projection multiplied by the market share projection.

The demand management team identifies which of one or more current or previous goods or services (number “p”, whereby p=1 to n) have similar properties or characteristics close to that of the new or replacement good or service at step 204. The time periods or life spans of the current and previous goods and services delivery data need not be the same. For each current or previous goods or services “p”, the time periods are defined as i=1 to tₚ (e.g., weeks, months, or quarters).

The Delivery Data (DD) is used to populate a template 300 (FIG. 3) in life cycle analysis component 116 at step 205. For current goods and services delivery data, the demand management team estimates the delivery data for the remainder of the life cycle at step 206. Existing delivery data (DDₚᵢ) is provided by the delivery history component 114. Estimated delivery data for the remainder of the current goods or services' life cycles are based on the following criteria: percentage of life span completed; volume of remaining deliveries; distribution of the remaining deliveries; and number of remaining time periods. The delivery data is then input to the template 300 of FIG. 3 via the life cycle analysis component 116.

One of the several strengths of the method is the capability to properly account for the impact of deliveries for goods and services in the announce and withdrawn periods based upon the number of days the good or service was delivered and the demand skew in the periods. The method provides eight adjustment procedures for mathematically adjusting the impact of deliveries for both time periods (i.e., announce (first) and withdraw (last)). The selection criteria for these procedures may depend upon the particular time periods with which the delivery data is organized within the delivery history component 114, as well as consideration for demand skew. These adjustment procedures ensure that the demand management team is able to use the delivery data information in the announce and withdrawn periods for current and previous goods and services, as well as make credible forecast volume statements for the announce and withdrawn periods for new and replacement goods or services. Without the adjustment procedures, the demand management team may not view the information in those announce and withdrawn periods as reliable for generating the forecasted volumes in those and adjacent periods.

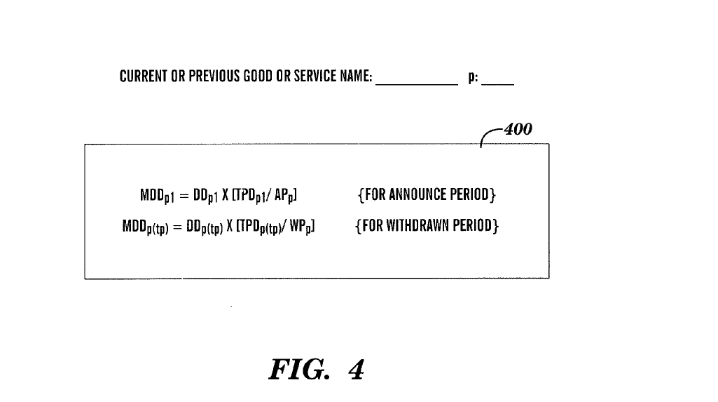

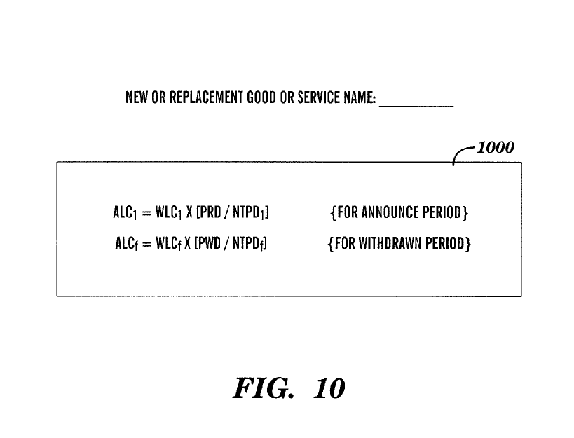

Two linear adjustment calculations that are used by the forecast decision support system method are shown in the templates 400 and 1000 of FIGS. 4 and 10, respectively. The key assumption in these linear adjustment calculations is that demand skew is not a factor (e.g., the demand for goods and services remains constant over the week, month or quarter). In other words, there is no statistically significant difference in demand from period to period.

Demand skew may be referred to as a variation of the demand distribution within a time period. Generally, these skewed demand patterns are not uniformly shaped based on existing business conditions or practices. The forecast decision support system is capable of adjusting the life cycle patterns of current and previous goods or services, as well as that of the new or replacement good or service. For delivery data maintained in weekly periods within a quarter, the demand pattern may be multi-modal. The percentage distribution across the time period assists the demand management team in more accurately reflecting delivery data in the announce (first) and withdrawn (last) time periods.

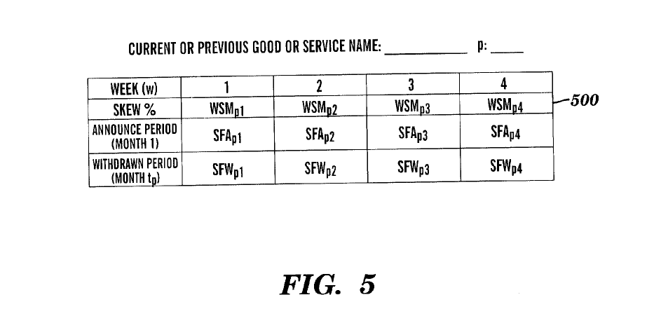

The six demand skew adjustment techniques and mathematical formulae utilized by the forecast decision support decision are shown and described with respect to the templates of FIGS. 5 through 7 and FIGS. 11 through 13. The demand skew adjustment procedure does not account for holidays or special events. The adjustment procedure uses the same demand skew percentages for both the announce and withdrawn time periods. This procedure converts the demand skew percentages (not all equal) to a skew factor (zero, fraction, or one) depending on the number of days the good or service was delivered within the specified time period (month or quarter). The demand skew percentage is multiplied by the associated skew factor and summed (always a fraction between zero and one). Situationally dependent, the fractional summation is added or subtracted from one and is the multiplicative factor for adjusting volumes.

The demand skew adjustment mathematical formulae are unique for six cases:

For current and previous goods and services:

Weekly demand skew adjustment calculations within monthly time periods (see FIG. 5)

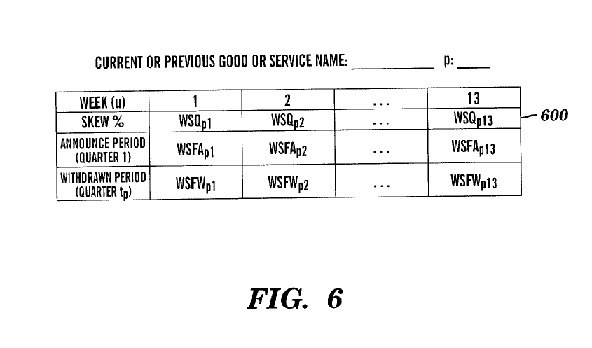

Weekly demand skew adjustment calculations within quarterly time periods (see FIG. 6)

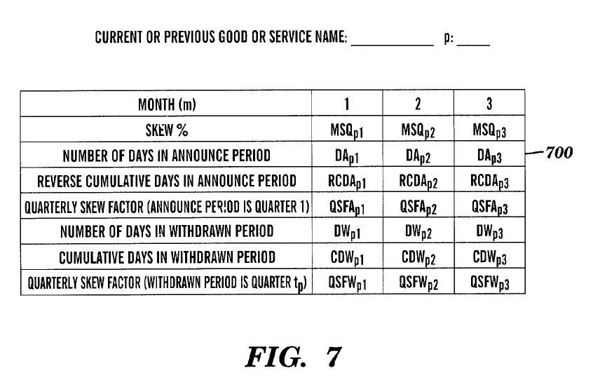

Monthly demand skew adjustment calculations within quarterly time periods (see FIG. 7)

For new or replacement goods and services:

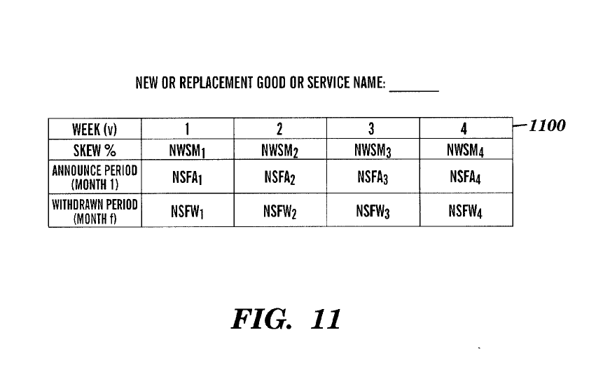

Weekly demand skew adjustment calculations within monthly time periods (see FIG. 11)

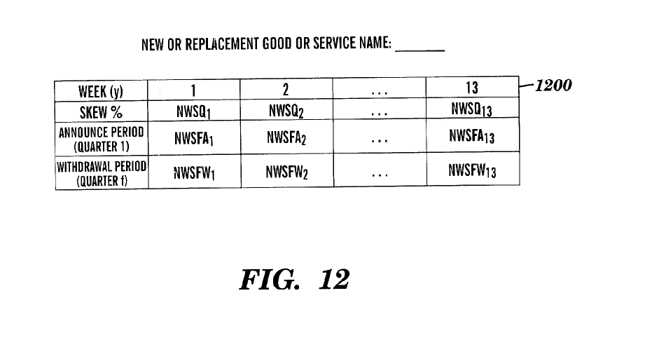

Weekly demand skew adjustment calculations within quarterly time periods (see FIG. 12)

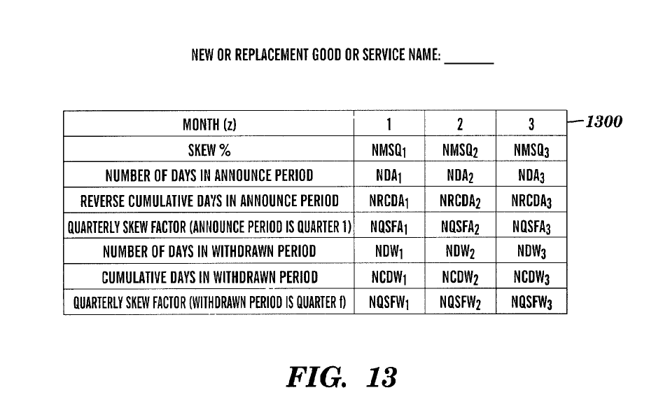

Monthly demand skew adjustment calculations within quarterly time periods (see FIG. 13)

FIGS. 4 through 7 each describes a method of adjusting the announce and withdrawn periods for current and previous goods or services. FIG. 4 utilizes linear adjustment and FIGS. 5 through 7 utilize demand skew adjustment. The adjustment process is performed at step 207. FIGS. 4 through 7 provide Modified Delivery Data (MDD) calculations for the announce (first) and withdrawn (last) time periods to FIG. 3. The Modified Delivery Data (MDD) adjustments for the announce (first) and withdrawn (last) periods are designated as MDD₁ and MDDₜₚ, respectively. The remaining MDD amounts may be expressed as MDDₚᵢ=DDₚᵢ, whereby i=2 to tp−1. The Modified Total Delivery Data (MTDD) is the sum of the MDD information and may be expressed as MTDDₚ=[Sum of MDDₚᵢ] whereby i=1 to tₚ.

FIG. 4 provides two formulae for implementing linear adjustment calculations for current or previous goods or services; one for an announce period and the other for a withdrawn period of a lifecycle. Linear adjustment is used for weekly time periods or when there is no delivery skew in monthly and quarterly time periods for current or previous good or service ‘p’, whereby p=1 to n, and time period ‘i’=1 or tₚ. This implementation further assumes that daily demand skew is not a factor. Time period days (TPDₚᵢ) for current or previous good or service ‘p’ is defined as follows: a week is seven days; a month is 28 to 31 days depending upon the applicable month; and a quarter is 90 to 92 days, depending upon the applicable quarter. Announce Period (APₚ) refers to the number of days a current or previous good or service ‘p’ sold in an announce period. Likewise, Withdrawn Period (WPₚ) refers to the number of days a current or previous good or service ‘p’ sold in a withdrawn period. Time period days (TPDₚᵢ) will always be greater than the announce (first) period (APₚ) and withdrawn (last) period (WPₚ).

FIG. 5 is a template 500 illustrating the weekly demand skew adjustment calculations (in monthly time periods) for current or previous goods or services. The calculations are implemented under an assumption that no holidays or special events are considered. In other words, the percentage demand skew is the same from month to month during the entire life cycle of the goods or services. The following elements of template 500 are defined as follows:

Weekly Skew in Month (WSM_{pw}), whereby p=1 to n and w=1 to 4 (weekly demand skew percentage for each month);

Sum of WSM_{pw}=1.0. If WSM_{pw} are all equal, then linear adjustment technique is used (see FIG. 4);

Number of Days current or previous goods or services “p” Sold in Announce Period (APₚ);

Skew Factor for Announce Period, or SFA_{pw} equals:

Zero (0) whereby [APₚ−(7×{5−w})]>=zero (0);

{1−[APₚ−(7×{4−w})]/7}, whereby negative 7(−7)<[APₚ−(7×{5−w})]<zero (0);

One (1) whereby [APₚ−(7×{5−w})]<=negative 7(−7);

Delivery Data (DDₚᵢ) are from the template 300 of FIG. 3, whereby p=1 to n and i=1 or tₚ;

Modified Delivery Data, or MDDₚ₁=DDₚ₁×[1+(Sum of {WSM_{pw}×SFA_{pw}})] is provided to the template 300 of FIG. 3;

Number of Days current or previous goods or services “p” Sold in Withdrawal Period (WPₚ);

Skew Factor for Withdrawal Period, or SFW_{pw} equals:

One (1) whereby [WPₚ−(7×w})]<=negative 7(−7);

{1−[WPₚ−(7×{w−1})]/7}, whereby negative 7(−7)<[WPₚ−(7×w)]<zero (0);

Zero (0) whereby [WPₚ−(7×w)]>=zero (0);

MDDₚ₍ₜₚ₎=DD ₚ₍ₜₚ₎×[1+(Sum of {WSM_{pw}×SFW_{pw}})] is provided to the template 300 of FIG. 3.

FIG. 6 is a template 600 illustrating the weekly demand skew adjustment calculations (in quarterly time periods) for current or previous goods or services. The calculations are implemented under an assumption that no holidays or special events are considered. In other words, the percentage demand skew is the same from quarter to quarter during the entire life cycle of the goods or services. The following elements of template 600 are defined as follows:

Weekly Skew in Quarter (WSQₚᵤ), whereby p=1 to n and u=1 to 13 (weekly demand skew percentage for each quarter);

Sum of WSQₚᵤ=1.0. If WSQₚᵤ are all equal, then the linear adjustment technique provided in FIG. 4 is used;

Number of Days current or previous goods or services “p” Sold in Announce Period (APₚ);

Weekly Skew Factor for Announce Period, or WSFAₚᵤ equals:

Zero (0), whereby [APₚ−(7×{14−u})]>=zero (0);

{1−[APₚ−(7×{13−u})]/7}, whereby negative 7(−7)<[APₚ−(7×{14−u})]<zero (0);

One (1), whereby [APₚ−(7×{14−u})]<=negative 7(−7);

Delivery Data (DDₚᵢ) are from the template 300 of FIG. 3, whereby p=1 to n, and i=1 or tₚ;

Modified Delivery Data, or MDDₚ₁=DDₚ₁×[1+(Sum of {WSQₚᵤ×WSFAₚᵤ})] is provided to the template 300 of FIG. 3;

Number of Days current or previous goods or services “p” Sold in Withdrawal Period (WPₚ);

Weekly Skew Factor for Withdrawal Period, or WSFWₚᵤ equals:

One (1), whereby [WPₚ−(7×u})]<=negative 7(−7);

{1−[WPₚ−(7×{u−1})]/7}, whereby negative 7(−7)<[WPₚ−(7×u)]<zero (0);

Zero (0), whereby [WPₚ−(7×u)]>=zero (0);

MDDₚ₍ₜₚ₎=DDₚ₍ₜₚ₎×[1+(Sum of {WSQₚᵤ×WSFWₚᵤ})] is provided to the template 300 of FIG. 3.

FIG. 7 is a template 700 illustrating the monthly demand skew adjustment calculations (in quarterly time periods) for current or previous goods or services. The calculations are implemented under an assumption that no holidays or special events are considered. In other words, the percentage demand skew is the same from quarter to quarter during the entire life cycle of the goods or services. The following elements of template 700 are defined as follows:

Monthly Skew in Quarter (MSQₚₘ), for product “p”, whereby p=1 to n and m=1 to 3 (monthly demand skew percentage for each quarter);

Sum of MSQₚₘ=1.0. If MSQₚₘ are all equal, then the linear adjustment technique of FIG. 4 is used;

Number of Days in Announce Period of current or previous goods or service “p” for each Month “m” (DAₚₘ), ranges from 28 to 31 days depending on the month;

Reverse Cumulative Days in Announce Period (RCDAₚₘ) are:

RCDAₚ₁=DAₚ₁+DAₚ₂+DAₚ₃;

RCDAₚ₂=DAₚ₂+DAₚ₃; and

RCDAₚ₃=DAₚ₃;

Number of Days current or previous goods or services “p” Sold in Announce Period (APₚ);

Quarterly Skew Factor for Announce Period, or QSFAₚₘ equals (in logical sequence):

Zero (0), whereby APₚ−RCDAₚₘ>=zero (0);

[(RCDAₚₘ−APₚ)/(DAₚₘ)], whereby negative DAₚₘ<[APₚ−RCDAₚₘ]<zero (0);

One (1), whereby [APₚ−RCDAₚₘ]<=negative DAₚₘ;

Delivery Data (DDₚᵢ) are received from the template 300 of FIG. 3 whereby p=1 to n, and i=1 or tₚ;

Modified Delivery Data, or MDDₚ₁=DDₚ₁×[1+(Sum of {MSQₚₘ×QSFAₚₘ})] are provided to the template 300 of FIG. 3;

Number of Days in Withdrawal Period of current or previous goods or service “p” for each Month “m” (DWₚₘ), ranges from 28 to 31 days depending on the month;

Cumulative Days in Withdrawal Period (CDWₚₘ) are:

CDWₚ₁=DWₚ₁;

CDWₚ₂=DWₚ₁+DWₚ₂; and

CDWₚ₃=DWₚ₁+DWₚ₂+DWₚ₃;

Number of Days current or previous goods or services “p” Sold in Withdrawal Period (WPₚ);

Quarterly Skew Factor for Withdrawal Period, or QSFWₚₘ equals (in logical sequence):

One (1), whereby [WPₚ−CDWₚₘ]<=negative DWₚₘ;

[(CDWₚₘ−WPₚ)/(DWₚₘ)], whereby negative DWₚₘ<[WPₚ−CDWₚₘ]<zero (0);

Zero (0), whereby [WPₚ−CDWₚₘ]>=zero (0);

MDDₚ₍ₜₚ₎=DDₚ₍ₜₚ₎×[1+(Sum of {MSQₚₘ×QSFWₚₘ})] is provided to the template 300 of FIG. 3.

The forecast decision support system method then normalizes each current or previous good or service delivery data to a Delivery Percentage (DP) and calculates the Cumulative Deliveries (CD) percentage at step 208 using the data provided in the template 300 of FIG. 3. This step converts the goods and services delivery data to one hundred (100) for analysis as a percentage and rapid translation into a cumulative percentage. The Delivery Percentage may be expressed as DPₚᵢ=[MDDₚᵢ/MTDDₚ]×100 whereby p=1 to n and time periods ‘i’=1 to tₚ for the number of time periods (i.e., weeks, months, or quarters). Cumulative Deliveries may be expressed as CDₚᵢ=CDₚ₋₁+DPₚᵢ whereby CDₚ₀=zero. The resulting information is then provided to the template 800 specified in FIG. 8.

The forecast decision support system method also computes the Cumulative Factor (CF) at step 209, which is a ratio of the number of time periods of the current or previous good or service and the forecasted number of time periods of the new or replacement good or service. One of the method's many strengths is the capability to normalize the disparate factors of overall lifecycle duration, different delivery history time frames (e.g., weeks, months, quarters, etc.), number of time periods, and volumes delivered to provide a singular and credible lifecycle demand pattern suitable for analysis and forecasting. The Cumulative Factor (CF) provides that capability of converting Cumulative Delivery (CD) percentages to Period Cumulative percentage in ‘f’ time periods. The Cumulative Factor (CF) is calculated in the template 800 of FIG. 8 as fraction [tₚ/f]. The Cumulative Factor may be expressed as CFₚ=tₚ/f, wherein tₚ are the time periods for current or previous goods or services ‘p’, whereby p=1 to n, and ‘f’ is the forecasted number of time periods of the new or replacement good or service. Cumulative Deliveries are calculated in the template 300 of FIG. 3 described above.

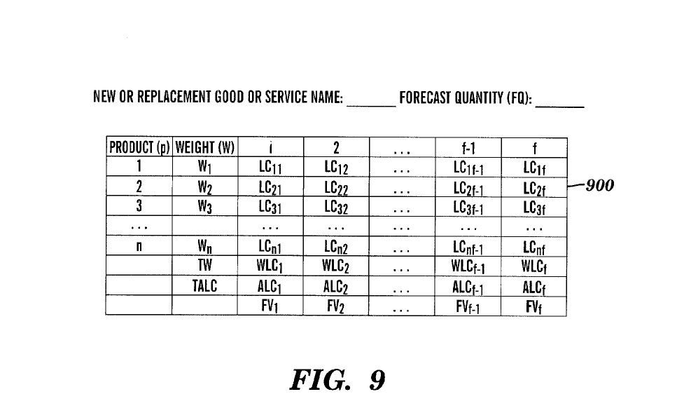

For each current or previous good or service, the forecast decision support method automatically computes the Period Cumulative Factor (PCF), and subsequently segments the PCF into an integer part (Period Cumulative Factor Integer) and decimal part (Period Cumulative Factor Decimal) at step 210. FIG. 8 provides the template 800 for these calculations. The Period Cumulative Factor may be expressed as PCFₚₖ=[CFₚ×k]. The ‘k’ in FIG. 8 refers to the number of time periods for a new or replacement good or service, whereby k=1 to f (weeks, months, quarters, etc.). The Period Cumulative Factor Integer may be expressed as PCFIₚₖ and is the integer component of PCFₚₖ. Techniques for determining the integer component of rational numbers are well known and will be understood by those skilled in the art. The Period Cumulative Factor Decimal is the decimal component of PCFₚₖ and may be expressed as PCFDₚₖ=PCFₚₖ−PCFIₚₖ. The forecast decision support system method computes two percentages (Cumulative Life Cycle (CLC) and Life Cycle (LC)) of the current or previous good or service. This step converts the life cycle percentage of the current or previous goods or services with life-span tₚ based on the life span ‘f’ of the new or replacement good or service. This unique translation retains the percentage character (i.e., 100), which is important in normalization processes, while changing the time dimension and associated volumes. The mathematical treatments for Cumulative Life Cycle (CLC) and Life Cycle (LC) are expressed below and the Life Cycle results are provided to the template 900 of FIG. 9 as follows:

Cumulative Life Cycle, or CLCₚₖ=CDₚ(PCFIₚₖ)+PCFDₚₖ×[CDₚ(PCFIₚₖ+1)−CDₚ(PCFIₚₖ)], whereby PCFIₚₖ is greater than zero (0);

Cumulative Life Cycle, or CLCₚₖ=PCFDₚₖ×CDₚ₁, whereby PCFIₚₖ=zero;

Life Cycle, or LCₚₖ=CLCₚₖ−CLCₚₖ₋₁, whereby CLCₚ₀=zero.

Once all of the current and previous Life Cycle (LC) Percentages have been calculated, this information is provided to a conversion template 900 as shown in FIG. 9 (e.g., the process converts many current and previous goods and services life cycles to a single new or replacement good or service volume forecast). The demand management team provides the differing weights (W) for each life cycle pattern at step 211 and calculates the Weighted Life Cycle (WLC) at step 212 (see FIG. 9). Weight may be expressed as (Wₚ), whereby Wₚ are integers providing relative rating between the life cycles for current or previous goods or services “p”, whereby p=1 to n. The Total Weight may be expressed as TW=[Sum of Wₚ], whereby TW need not equal 100. Life Cycle (LCₚₖ) is obtained from the template 800 of FIG. 8. The Weighted Life Cycle may be expressed as WLCₖ=[Sum of {Wₚ×LCₚₖ}]/TW.

FIG. 10 (linear adjustment) and FIGS. 11 through 13 (demand skew adjustment) are four methods of adjusting the announce and withdrawn periods for new and replacement good or service. The forecast decision support system method calculates the Adjusted Life Cycle (ALC) for each time period at step 213 by automatically adjusting the Weighted Life Cycle (WLC) for the announce (first) and withdrawn (last) periods to incorporate the number of days the new or replacement good or service will be sold. The Adjusted Life Cycle may be expressed as ALCₖ=WLCₖ, whereby k=2 to f−1. Specific procedures for calculating ALC₁ and ALC_{f} (linear or skew adjustment techniques for announce and withdrawn periods) are shown in FIGS. 10 through 13. The Total Adjusted Life Cycle may be expressed as TALC=[Sum of ALCₖ]. Based on the Forecasted Quantity (FQ) from step 203 of FIG. 2, the forecast decision support system method calculates the Forecasted Volume (FV) over “f” time periods for the new or replacement good or service at step 214. The Forecasted Volume may be expressed as FVₖ=[ALCₖ×{FQ/TALC}]. Additionally, the weighting scheme and/or forecasted quantity (FQ) can be used for sensitivity analysis or ‘what if’ scenarios to ascertain various forecasted volumes for different business situations.

FIG. 10 provides two formulae for implementing linear adjustment calculations for the new or replacement good or service; one for an announce period and the other for the withdrawn period of a life cycle. Linear adjustment is used for weekly time periods or when there is no delivery skew in monthly and quarterly time periods for a new or replacement good or service. This implementation further assumes that demand skew is not a factor in weekly time periods. New Time Period Days (NTPDₖ) for new or replacement good or service is defined as follows: a week is seven days; a month is 28 to 31 days depending on the applicable month; and a quarter is 90 to 92 days, depending upon the applicable quarter. Planned Release Days (PRD) is the number of days the new or replacement service will be sold in the announce period. Planned Withdrawal Days (PWD) is the number of days the new or replacement service will be sold in the withdrawal period. New Time Period Days (NTPDₖ) will always be greater than PRD and PWD.

FIG. 11 is a template 1100 illustrating the weekly demand skew adjustment calculations (in monthly time periods) for new or replacement good or service. The calculations are implemented under an assumption that no holidays or special events are considered. In other words, the percentage demand skew is the same from month to month during the entire life cycle of the good or service. The following elements of template 1100 are defined as follows:

New Weekly Skew in Month (NWSMᵥ), whereby v=1 to 4 (weekly demand skew percentage for each month);

Sum of NWSMᵥ=1.0. If NWSMᵥ are all equal, then the linear adjustment technique of FIG. 10 is used;

Planned Release Days (PRD) is the number of days the new or replacement good or service is sold in the announce period;

New Skew Factor for Announce Period, or NSFAᵥ equals:

Zero (0), whereby [PRD−(7×{5−v})]>=zero (0);

{1−[PRD−(7×{4−v})]/7}, whereby negative 7(−7)<[PRD−(7×{5−v})]<zero (0);

One (1), whereby [PRD−(7×{5−v})]<=negative 7(−7);

Weighted Life Cycle (WLCₖ), whereby k=1 or f (from the template 900 of FIG. 9);

Adjusted Life Cycle, or ALC₁=WLC₁×[1−(Sum of {NWSMᵥ×NSFAᵥ})] is provided to the template 900 of FIG. 9;

Planned Withdrawal Days (PWD) is the number of days the new or replacement good or service is sold in the withdrawal period (f);

New Skew Factor for Withdrawal Period, or NSFWᵥ equals:

One (1), whereby [PWD−(7×v})]<=negative 7(−7);

{1−[PWD−(7×{v−1})]/7}, whereby negative 7(−7)<[PWD−(7×v)]<zero (0);

Zero (0), whereby [PWD−(7×v)]>=zero (0);

ALC_{f}=WLC_{f}×[1−(Sum of {NWSMᵥ×NSFWᵥ})] is provided to the template 900 of FIG. 9.

FIG. 12 is a template 1200 illustrating the weekly demand skew adjustment calculations (in quarterly time periods) for new or replacement good or service. The calculations are implemented under an assumption that no holidays or special events are considered. In other words, the percentage demand skew is the same from quarter to quarter during the entire life cycle of the good or service. The following elements of template 1200 are defined as follows:

New Weekly Skew in Quarter (NWSQ_{y}), whereby y=1 to 13 (weekly demand skew percentage for each quarter);

Sum of NWSQ_{y}=1.0. If NWSQ_{y} are all equal, then the linear adjustment technique of FIG. 10 is used;

Planned Release Days (PRD) is the number of days the new or replacement good or service is sold in the announce period;

New Weekly Skew Factor for Announce Period, or NWSFA_{y} equals:

Zero (0), whereby PRD−(7×{14−y})]>=zero (0);

{1−[PRD−(7×{13−y})]/7}, whereby negative 7(−7)<[PRD−(7×{14−y})]<zero (0);

One (1), whereby [PRD−(7×{14−y})]<=negative 7(−7);

Weighted Life Cycle (WLCₖ), whereby k=1 or f (from the template 900 of FIG. 9);

Adjusted Life Cycle, or ALC₁=WLC₁×[1−(Sum of {NWSQ_{y}×NWSFA_{y}})] is provided to the template 900 of FIG. 9;

Planned Withdrawal Days (PWD) is the number of days the new or replacement good or service is sold in the withdrawal period (f);

New Weekly Skew Factor for Withdrawal Period, or NWSFW_{y} equals:

One (1), whereby [PWD−(7×y})]<=negative 7(−7);

{1−[PWD−(7×{y−1})]/7}, whereby negative 7(−7)<[PWD−(7×y)]<zero (0);

Zero (0), whereby [PWD−(7×y)]>=zero (0);

ALC_{f}=WLC_{f}×[1−(Sum of {NWSQ_{y}×NWSFW_{y}})] is provided to the template 900 of FIG. 9.

FIG. 13 is a template 1300 illustrating the monthly demand skew adjustment calculations (in quarterly time periods) for new or replacement good or service. The calculations are implemented under an assumption that no holidays or special events are considered. In other words, the percentage demand skew is the same from quarter to quarter during the entire life cycle of the good or service. The following elements of template 1300 are defined as follows:

New Monthly Skew in Quarter (NMSQ_{z}), whereby z=1 to 3 (monthly demand skew percentage for each quarter);

Sum of NMSQ_{z}=1.0. If NMSQ_{z} are all equal, then the linear adjustment technique of FIG. 10 is used;

For Announce Period, new or replacement good or service Number of Days in each Month (NDA_{z}), ranges from 28 to 31 days depending on the month;

New Reverse Cumulative Days in Announce Period (NRCDA_{z}):

NRCDA₁=NDA₁+NDA₂+NDA₃

NRCDA₂=NDA₂+NDA₃

NRCDA₃=NDA₃;

Planned Release Days (PRD) is the number of days the new or replacement good or service is sold in the announce period;

New Quarterly Skew Factor for Announce Period, or NQSFA_{z} equals:

Zero (0), whereby PRD−NRCDA_{z}>=zero (0);

[(NRCDA_{z}−PRD)/(NDA_{z})], whereby negative NDA_{z}<[PRD−NRCDA_{z}]<zero (0);

One (1), whereby [PRD−NRCDA_{z}]<=negative NDA_{z};

Weighted Life Cycle (WLCₖ), whereby k=1 or f are from the template 900 of FIG. 9;

Adjusted Life Cycle, or ALC₁=WLC₁×[1−(Sum of {NMSQ_{z}×NQSFA_{z}})] is provided to the template 900 of FIG. 9;

For Withdrawal Period, new or replacement good or service Number of Days in each Month (NDW_{z}), ranges from 28 to 31 days depending on the month;

New Cumulative Days in Withdrawal Period (NCDW_{z}) are:

NCDW₁=NDW₁;

NCDW₂=NDW₁+NDW₂;

NCDW₃=NDW₁+NDW₂+NDW₃;

Planned Withdrawal Days (PWD) is the number of days the new or replacement good or service is sold in the withdrawal period (f);

New Quarterly Skew Factor for Withdrawal Period, or NQSFW_{z} equals:

One (1), whereby [PWD−NCDW_{z}]<=negative NDW_{z};

[(NCDW_{z}−PWD)/(NDW_{z})], whereby negative NDW_{z}<[PWD−NCDW_{z}]<zero (0);

Zero (0), whereby [PWD−NCDW_{z}]>=zero (0);

ALC_{f}=WLC_{f}×[1−(Sum of {NMSQ_{z}×NQSFW_{z}})] is provided to the template 900 of FIG. 9.

The forecast decision support system method also provides the graphical representation of all life cycle patterns and forecasted volumes of the new or replacement good or service at step 215. FIG. 14 provides an example of this graphical representation. As shown in FIG. 14, the current and previous life cycle patterns (as a percentage) are displayed on the top graphic, with the bottom graphic providing the new or replacement good or service forecast (as a volume).

As required, the process as described above may be repeated for each new or replacement good or service returning to step 201 of FIG. 2.

The manufacturing and service industries are driving to weekly forecasts, therefore the method of adjusting for skew in the announce (first) and withdrawn (last) time periods is becoming more significant. There are no known methods to fully compensate for partial weekly delivery data within a month or quarter, i.e., the first and last weeks of each month or quarter may be less than 7 days. For the demand skew adjustment techniques outlined in FIGS. 4, 7, 10, and 13, the techniques and mathematical operations are completely accurate. However, for the weekly demand skew adjustment techniques for partial weekly delivery data and forecasted volumes outlined in FIGS. 5, 6, 11, and 12, there is the slight potential for error in the announce (first) and withdrawn (last) time periods.

For FIGS. 5, 6, 11, and 12, the Announce Probability Error (APE) and Withdrawal Probability Error (WPE) for partial weekly delivery data and forecasted volumes can be defined as [7—actual calendar days in the week] divided by the number of calendar days within the month or quarter for the corresponding (announce or withdrawn) time period. Actual calendar days may vary in the first week of the announce month or quarters since the starting day of the month is not necessarily on a Sunday, and the last week of the withdrawal month or quarter, since the last day of the month is not necessarily on a Saturday. The range of the numerator is zero through six (minimum to maximum), with an equitable distribution of each value of the range over the 7 days of the week. Therefore, the probability of an error per day of the week is 0.14 for each number of days. Hence, the maximum error probability over a month is 0.21[ 6/28] or quarter is 0.07[ 6/90] (February and first quarter (of January, February, and March) are used respectively since February is the shortest month, hence has the smallest denominator in both calculations to compute the maximum error probability). For other months and quarters, the maximum error probability will be less than 0.21 and 0.07 respectively, since the denominator will be larger.

This error should be accounted for in FIGS. 3, 8, and 9 when conducting any analysis. If all of the derived probability errors (APE or WPE) from FIGS. 4 and 7 or FIGS. 11 and 12 are ‘zero’ for a specific time period, then the average error probability for FIGS. 8 and 9, respectively, for that time period is ‘zero’.

For FIGS. 3 and 8, if one or more of the probability errors (APE or WPE) is greater than zero, then the Average Error Probability (AEP) is the sum of all of the errors divided by the number of current or previous goods or services' time periods (“n”) used. The Central Limit Theorem stipulates that as “n” becomes larger, the Average Error Probability (AEP) tends between zero (0) and 0.11 (maximum).

For FIG. 9, if one or more of the probability errors is greater than zero, then the Average Error Probability (AEP) is generally less than or equal to 0.21, and the number of forecasted periods “f” becomes larger, the error becomes smaller in significance.

The potential for error without the adjustment technique is higher than with the adjustment technique. The Potential Error Probability (PEP) (without the adjustment technique) is one (1) minus the Average Error Probability (AEP) (with the adjustment technique) [i.e., PEP=1−AEP]. Hence, the minimum Potential Error Probability (PEP) is 0.79, which is substantially greater than the maximum Average Error Probability (AEP) of 0.21.

This error calculation is used to assess the delivery data and forecasted volumes in the announce (first) and withdrawn (last) time periods. The life cycle percentages of these specific time periods are low considering that we are discussing weekly time frames. This error calculation does not affect the other time periods. Hence, a low life cycle percentage of announce and withdrawn time periods multiplied by a maximum of 0.11 (for current or previous goods or services) and 0.21 (for new or replacement good or service) will produce a relatively small error when compared to the total forecasted volume of the entire life cycle.

Even though the method does introduce a modest degree of adjustment error in the announce (first) and withdrawn (last) time periods, to not exploit the adjustment would incur a larger potential error in the method. Therefore, the adjustment for skew in the weekly adjustment methods is preferred and should be viewed as optimal solution within the method.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for developing a forecast of goods or services, comprising:
identifying current or previous goods or services that have characteristics similar to those of a new or replacement good or service to be forecasted; obtaining delivery data associated with the current or previous goods or services; adjusting delivery volume data of the current or previous goods or services for corresponding announce and withdrawn time periods, resulting in a modified delivery data; and
using the modified delivery data in conjunction with planned release and withdrawal dates and forecasted time periods and quantities associated with the new or replacement good or service, translating lifecycle patterns for the current or previous goods or services into a lifecycle forecast for the new or replacement good or service.

2. The method of claim 1, wherein the obtaining delivery data includes at least one of: obtaining historical delivery data for the previous good or service; and
estimating remainder of lifecycles for the current good or service based upon at least one of:
percentage of lifespan completed;
volume of remaining deliveries;
distribution of remaining deliveries; and
number of remaining time periods in the lifecycle.

3. The method of claim 1, wherein the adjusting is via linear adjustment calculations.

4. The method of claim 3, wherein the linear adjustment calculations is for a current or previous good or service.

5. The method of claim 3, wherein the linear adjustment calculations is for a new or replacement good or service.

6. The method of claim 1, wherein the adjusting is via demand skew adjustment calculations.

7. The method of claim 6, wherein the demand skew adjustment calculation is for a current or previous good or service.

8. The method of claim 6, wherein the demand skew adjustment calculation is for a new or replacement good or service.

9. The method of claim 1, wherein the adjusting delivery volume data includes normalizing delivery data for the current or previous good or service to a delivery percentage and calculating a cumulative delivery percentage.

10. The method of claim 1, wherein the adjusting delivery volume data further includes computing a cumulative factor via a ratio of a number of time periods of the current or previous good or service and a forecasted number of time periods of the new or replacement good or service.

11. A storage medium encoded with machine-readable program code for developing a forecast of goods or services, the program code including instructions for causing a host system to implement a method, comprising:
identifying current or previous goods or services that have characteristics similar to those of a new or replacement good or service to be forecasted;
obtaining delivery data associated with the current or previous goods or services;
adjusting delivery volume data of the current or previous goods or services for corresponding announce and withdrawn time periods, resulting in a modified delivery data; and
using the modified delivery data in conjunction with planned release and withdrawal dates and forecasted time periods and quantities associated with the new or replacement good or service, translating lifecycle patterns for the current or previous goods or services into a lifecycle forecast for the new or replacement good or service.

12. The storage medium of claim 11, wherein the obtaining delivery data includes at least one of:
obtaining historical delivery data for the previous good or service; and
estimating remainder of lifecycles for the current good or service based upon at least one of:
percentage of lifespan completed;
volume of remaining deliveries;
distribution of remaining deliveries; and
number of remaining time periods in the lifecycle.

13. The storage medium of claim 11, wherein the adjusting is via linear adjustment calculations.

14. The storage medium of claim 13, wherein the linear adjustment calculations is for a current or previous good or service.

15. The storage medium of claim 13, wherein the linear adjustment calculations is for a new or replacement good or service.

16. The storage medium of claim 11, wherein the adjusting is via demand skew adjustment calculations.

17. The storage medium of claim 16, wherein the demand skew adjustment calculation is for a current or previous good or service.

18. The storage medium of claim 16, wherein the demand skew adjustment calculation is for a new or replacement good or service.

19. The storage medium of claim 11, wherein the adjusting delivery volume data includes normalizing delivery data for the current or previous good or service to a delivery percentage and calculating a cumulative delivery percentage.

20. The storage medium of claim 11 wherein the adjusting delivery volume data further includes computing a cumulative factor via a ratio of a number of time periods of the current or previous good or service and a forecasted number of time periods of the new or replacement good or service.

21. A system for developing a forecast of goods or services, comprising:
a host system executing an enterprise resource planning application, the enterprise resource planning application including a demand management component, a delivery history component, and a lifecycle analysis component;
a storage device in communication with the host system; and
a link to at least one client system; wherein the enterprise resource planning application performs:
identifying current or previous goods or services that have characteristics similar to those of a new or replacement good or service to be forecasted via the demand management component and the lifecycle analysis component;
obtaining delivery data associated with the current or previous goods or services via the delivery history component;
adjusting delivery volume data of the current or previous goods or services for corresponding announce and withdrawn time periods via the lifecycle analysis component, the adjusting resulting in a modified delivery data; and
using the modified delivery data in conjunction with planned release and withdrawal dates and forecasted time periods and quantities associated with the new or replacement good or service, translating lifecycle patterns for the current or previous goods or services into a lifecycle forecast for the new or replacement good or service.

22. The system of claim 21, wherein the obtaining delivery data includes at least one of:
obtaining historical delivery data for the previous good or service; and
estimating remainder of lifecycles for the current good or service based upon at least one of:
percentage of lifespan completed;
volume of remaining deliveries;
distribution of remaining deliveries; and
number of remaining time periods in the lifecycle.

23. The system of claim 21, wherein the adjusting is via linear adjustment calculations.

24. The system of claim 23, wherein the linear adjustment calculations is for a current or previous good or service.

25. The system of claim 23, wherein the linear adjustment calculations is for a new or replacement good or service.

26. The system of claim 21, wherein the adjusting is via demand skew adjustment calculations.

27. The system of claim 26, wherein the demand skew adjustment calculation is for a current or previous good or service.

28. The system of claim 26, wherein the demand skew adjustment calculation is for a new or replacement good or service.

29. The system of claim 21, wherein the adjusting delivery volume data includes normalizing delivery data for the current or previous good or service to a delivery percentage and calculating a cumulative delivery percentage.

30. The system of claim 21, wherein the adjusting delivery volume data further includes computing a cumulative factor via a ratio of a number of time periods of the current or previous good or service and a forecasted number of time periods of the new or replacement good or service.
